(19) United States
(12) Patent Application Publication
(10) Pub. No.: US 2013/0208102 A1
(43) Pub. Date: Aug. 15, 2013

(54) SKIN PICTURING DEVICE

(71) Applicants: Jongyoul Kim, Busan (KR); Yongnam Park, Busan (KR); Jinnam Park, Yangsan-si (KR); Junho Jeong, Ulsan (KR)

(72) Inventors: Jongyoul Kim, Busan (KR); Yongnam Park, Busan (KR); Jinnam Park, Yangsan-si (KR); Junho Jeong, Ulsan (KR)

(21) Appl. No.: 13/699,824

(22) PCT Filed: Oct. 31, 2012
(86) PCT No.: PCT/KR12/09034

§ 371 Date: Nov. 26, 2012

(30) Foreign Application Priority Data
Oct. 31, 2011 (KR) 10-2011-0112118

(51) Int. Cl. H04N 5/225

(52) U.S. Cl. CPC H04N 5/2251
USPC 348/77

(57) ABSTRACT

The embodiment of the invention relates to a skin photographing apparatus. A skin photographing apparatus includes a bottom surface horizontally positioned; a subject-mounted portion vertically positioned to be perpendicular to the bottom surface, wherein a face of a person to be photographed is mounted on the subject-mounted portion; and a supporting portion for supporting a lower side of a camera so that the camera is mounted on an upper side of the supporting portion.

### TECHNICAL FIELD

The present invention relates to a skin photographing apparatus, and more particular, to a skin photographing apparatus being able to be used regardless of a type of a camera and to adjust a position of the camera and a subject.

### BACKGROUND ART

A skin measuring apparatus generally measures and diagnoses a state of a face of a human body. The skin measuring apparatus magnifies the skin through using a lens, digitalizes the magnified image of the skin through using an image detecting device (such as, a charge-coupled device camera), and transfers the digitalized image of the skin to a computer or an image processing device for analyzing the digitalized image of the skin.

Detailed information of a skin state (such as, a size and a dispersed pattern of wrinkles of the skin, a size and a dispersed pattern of pores of the skin, and so on) can be known through using the skin measuring apparatus. The light irradiated to the skin is an important factor for analyzing the information of the skin state, and the camera plays an important role also.

However, the conventional apparatus or method has problems as follows.

The camera is the most expensive of elements of a skin photographing apparatus. The camera of a user cannot be applied to the skin photographing apparatus, and thus, the cost of the skin photographing apparatus increases.

Also, the position of the camera of the skin photographing apparatus is fixed, and therefore, the face of the person for photographing cannot be photographed at various angles (for example, a side surface of the face of the person cannot be photographed).

### DISCLOSURE

### Technical Problem

The present invention is directed to provide a skin photographing apparatus where cameras of various types can be applied.

The present invention is directed to provide a skin photographing apparatus that a person for photographing is fixed and a position of a camera can be variously adjusted.

### Technical Solution

A skin photographing apparatus according to an embodiment includes a bottom surface horizontally positioned; a subject-mounted portion vertically positioned to be perpendicular to the bottom surface, wherein a face of a person to be photographed is mounted on the subject-mounted portion; and a supporting portion for supporting a lower side of a camera so that the camera is mounted on an upper side of the supporting portion.

The skin photographing apparatus may further include a rail portion extending from the subject-mounted portion to be parallel to the bottom surface. The camera may be mounted on the upper side of the supporting portion and may move along the rail portion so that the camera gets near to or grows apart from the subject-mounted portion.

The rail portion may be pivotable around the subject-mounted portion.

The skin photographing apparatus may further include a reflector having a conical shape. The reflector may be positioned at an edge of a lens of the camera and extends toward the subject-mounted portion.

The skin photographing apparatus may further include a lighting portion positioned at an edge of the reflector.

The skin photographing apparatus may further include a casing having an inner space; a lighting portion positioned at an edge of one side surface of the case, wherein the lighting portion for providing lighting for the camera; and a cover portion for shielding a hole penetrating the one side surface of the casing where the supporting portion is installed. The supporting portion may be formed at an outer wall of the one side surface of the casing. The supporting portion may be movable up and down, from front to back, and from side to side with respect to the casing. The camera may be fixed to the upper side of the supporting portion, and the subject-mounted portion may be formed at a side surface facing the one side surface of the casing where the supporting portion is positioned.

The lighting portion may include light emitting diode portions arranged to face each other, wherein the light emitting diode portions are formed at an edge of one side wall of the casing; a diffuser plate for partitioning a space where the light emitting diode portions are positioned and the other space in the casing; and a fixing plate vertically protruding to an inner side at a portion where an inner wall of the casing and the diffuser plate are in contact.

The supporting portion may include a first control portion supporting the lower side of the camera and being fixed to be movable up and down along a guide hole of the casing; a second control portion fixed to be movable so that the camera gets near to or grows apart from the casing; and a third control portion fixed so that the camera horizontally moves.

The first control portion may include a first guide having a plurality of penetrating holes formed in a longitudinal direction, wherein the plurality of penetrating holes corresponding a guide hole; and a first set screw penetrating one of the plurality of penetrating holes and being fixed to the guide hole.

The second control portion may include a second rail fixed to be perpendicular to the first guide; a second guide moving along the second rail; and a second set screw installing the second guide, wherein the second set screw penetrating the second guide and being fixed to the second rail.

The third control portion may include a third rail formed at an upper surface of the second guide and fixed to be perpendicular to the second guide; a third guide moving along the third rail, wherein the camera is fixed at the upper side of the third guide; and a third set screw penetrating the third guide and being fixed to the third rail.

The light emitting diode portion may is inclined toward the diffuser plate, and an inclined angle of the light emitting diode portion may be adjustable.

The subject-mounted portion may include a subject-mounted hole being open so that a face of a person for photographing passes into the casing through the subject-mount hole; a lower supporting portion being positioned at a lower side of the subject-mounted hole and supporting a chin of the person; and a upper supporting portion being positioned at an upper side of the subject-mounted hole and supporting an incline of the face of the person.

### Advantageous Effects

The skin photographing apparatus according to the embodiments have advantages as follows.

Cameras of various types can be installed on the skin photographing apparatus according to the embodiments, and thus, a total cost of the skin photographing apparatus can decrease.

The rail is positioned at the lower side of the camera, the camera moves along the rail, and the rail pivots around the subject-mounted portion. Accordingly, the face of the person can be photographed at several angles and a lot of information can be obtained.

That is, the above technical features of the invention may be achieved through other specific embodiments by skilled person in the art to which the invention pertains without changing the technical features or necessary property.

### DESCRIPTION OF DRAWINGS

FIG. 1 is a side cross-sectional view of a skin photographing apparatus according to a first embodiment of the invention.

FIG. 2 is a front view of the skin photographing apparatus according to the first embodiment shown in FIG. 1.

FIG. 3 is a plan view of the skin photographing apparatus according to the first embodiment shown in FIG. 1.

FIG. 4 is a front view illustrating elements for supporting a face that is a subject for photographing, in the skin photographing apparatus according to the first embodiment shown in FIG. 1.

FIG. 5 is a front view of the skin photographing apparatus according to the first embodiment shown in FIG. 1 in the state that the supporting portion is eliminated.

FIG. 6 is a side cross-sectional view of a skin photographing apparatus according to another example of the first embodiment of the invention.

FIG. 7 is a side cross-sectional view of a skin photographing apparatus according to still another example of the first embodiment of the invention.

FIG. 8 is a side view of a skin photographing apparatus according to a second embodiment of the invention.

FIG. 9 is a front view of a subject-mounted portion of the skin photographing apparatus according to the second embodiment of the invention.

FIG. 10 is a plan view of a bottom surface and a rail portion of the skin photographing apparatus according to the second embodiment of the invention.

FIG. 11 is a front view of a supporting portion of the skin photographing apparatus according to the second embodiment of the invention.

FIG. 12 is a front view illustrating a reflector-supporting portion of the skin photographing apparatus according to the second embodiment of the invention.

### DETAILED DESCRIPTION OF EMBODIMENTS

Hereinafter, a skin photographing apparatus according to an embodiment of the invention will be described with reference to the accompanying drawings.

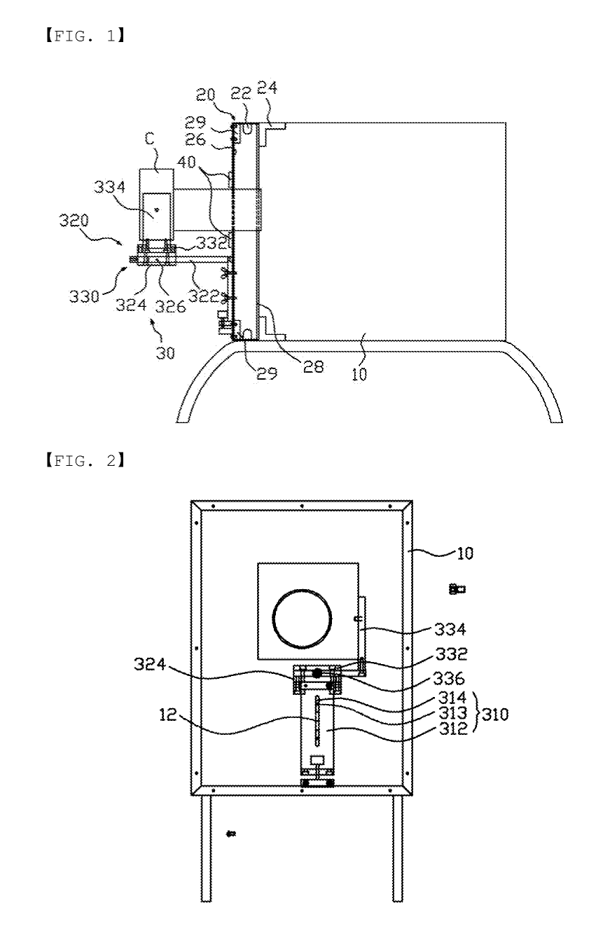

As shown in FIG. 1, a skin photographing apparatus (a skin diagnosis apparatus or a skin measuring apparatus) according to a first embodiment of the invention includes a casing 10, a lighting portion 20, a supporting portion 30, and a cover portion 40, and a subject-mounted portion 50. The casing 10 has an inner space and is sealed. The lighting portion 20 is positioned at edges adjacent to a side surface of the casing 10 to provide lighting to a camera C. The supporting portion 30 is positioned at an outer wall of the side surface of the casing 10. The supporting portion 30 is movable up and down, from front to back, and from side to side with respect to the casing 10. The camera C is fixed on an upper surface of the supporting portion 30. The cover portion 40 shields a hole 14 penetrating the side surface of the casing 10 where the supporting portion 30 is installed. The subject-mounted portion 50 is formed at the other surface facing the side surface of the casing 10 where the supporting portion 30 is positioned.

First, the skin photographing apparatus according to the embodiment includes the casing 10. As shown in FIG. 1, the casing 10 has the predetermined inner space, and is sealed so that the inner space is shut off from an outside.

Also, the lighting portion 20 is positioned at the side surface of the casing 10. As shown in FIG. 1, the lighting portion 20 is positioned at the side surface of the casing 10 and provides lighting to the camera C for photographing a skin.

Various types or structures for providing lighting to the camera C are applied to the lighting portion 20. For example, as shown in FIG. 1, the lighting portion 20 may include light emitting diode portions 22, a diffuser plate 28, and fixing plates 24. The light emitting diode portions 22 are arranged at edges of one side wall of the casing 10 to face each other. The diffuser plate 28 is formed in front of the light emitting diode portions 22(between the side wall of the casing 10 and the subject-mounted portion 50). The fixing plates 24 are positioned at portions where inner side walls of the casing 10 and the diffuser plate 28 are in contact. The fixing plate 24 extends at an edge of the diffuser plate 28 and is vertically bent to protrude along the inner wall of the casing 10 toward an inner side of the casing 10.

That is, the diffuser plate 28 is fixed to the fixing plate 24 and is fixed to the inner wall of the casing 10. Also, the fixing plate 24 blocks the light generated from the light emitting diode portion 22 and prevents the light from traveling straight to the subject-mounted portion 50.

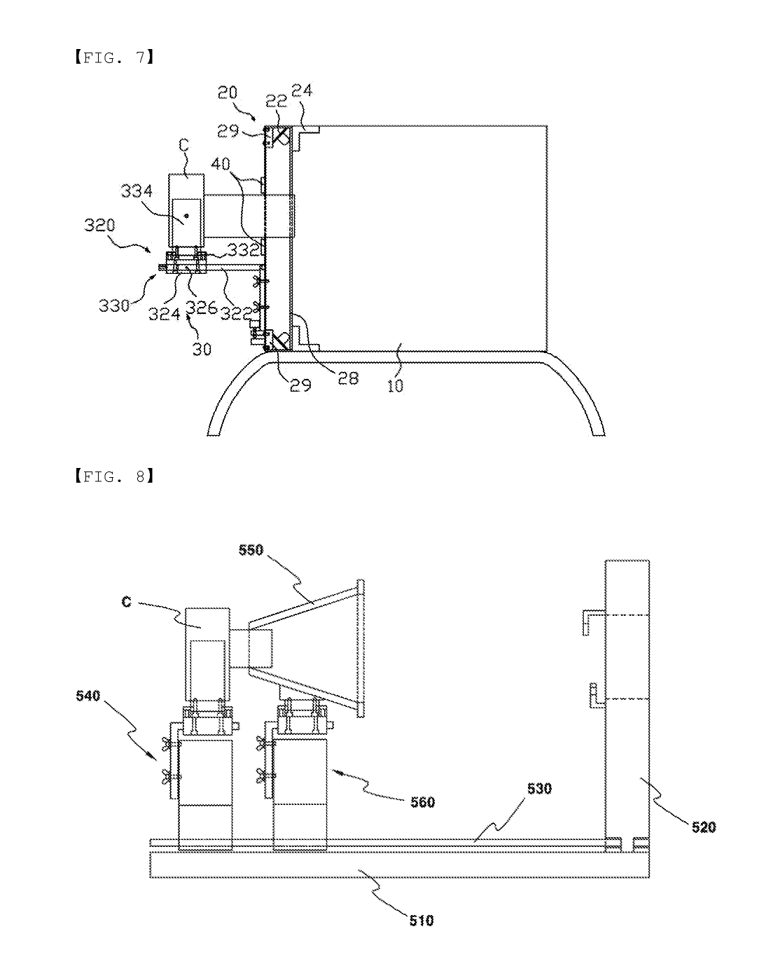

In this instance, as shown in FIG. 1, the light emitting diode portions 22 face each other. Alternatively, as shown in FIG. 7, the light emitting diode portions 22 may be positioned to be inclined to the diffuser plate 28 for effectively delivering the light. Also, the inclined degree (angle) of the light emitting diode portion 22 may be changed or adjusted.

In addition, a reflective film 26 is formed at the inner side wall of the casing 10 where the light emitting diode portions 22 are positioned or adjacently positioned. This is for effectively scattering the light generated from the light emitting diode portion 22 in the casing 10.

As shown in FIG. 6, the reflective film 26 may be inclined to the edge of the light emitting diode portion 22 so that the light of the light emitting diode portion 22 can be guided to be reflected.

Also, the diffuser plate 28 is further positioned in front of the light emitting diode portion 22. The diffuser plate 28 uniformly diffuses the light generated from the light emitting diode portion 22 to the whole inner space of the casing 10.

In addition, a reinforced portion (or reinforced portions) 29 is positioned at the inner wall of the casing 10 where the light emitting diode portions 22 are formed (more particularly, the inner wall of the casing 10 where the supporting portion 30 is formed). The reinforced portion 29 bears the weight of the supporting portion 30, the camera C, and so on.

Further, the skin photographing apparatus according to the embodiment includes the supporting portion 30. As shown FIG. 1 to FIG. 3, the supporting portion 30 is positioned at an outer wall of the side surface of the casing 10. In addition, the camera C is mounted on and is fixed to an upper side of the supporting portion 30. The supporting portion 30 is movable up and down, from front to back, and from side to side with respect to the casing 10.

As shown in FIG. 1 to FIG. 3, the supporting portion 30 may include a first control portion 310, a second control portion 320, and a third control portion 330. The first supporting portion 310 supports the lower side of the camera C, and is fixed to be movable up and down along a guide hole 12 of the casing 10. The second control portion 320 is fixed to move the camera C so that the camera C gets near to or grows apart from the casing 10. The third control portion 330 is fixed to horizontally move the camera C.

First, as shown in FIG. 2, the supporting portion 30 includes the first control portion 310. The first control portion 310 includes a first guide 312 for moving the camera C up and down at the side surface of the casing 10. A plurality of penetrating holes 313 are formed at the first guide 312 in a longitudinal direction of the first guide 312, and correspond to a guide hole 12 formed at the side wall of the casing 10.

The penetrating hole 313 of the first guide 312 is provided with a first set screw 314. The first set screw 314 penetrates one of the penetrating holes 313 and is fixed to the guide hole 12, and thereby fixing the first guide 312 to the casing 10.

Also, as shown in FIG. 1, the supporting portion 30 includes the second control portion 320. The second control portion 320 moves the camera C so that the camera C gets near to or grows apart from the casing 10.

The second control portion 320 includes a second rail 322 fixed to be perpendicular to the first guide 312. As shown in FIG. 1, the second rail 322 is perpendicular to the first guide 312 so that the second guide 324 that the camera C is mounted thereon gets near to or grows apart from the casing 10 along the second rail 322.

The second guide 324 is provided with a second set screw 326. The second set screw 326 penetrates the second guide 324 and is fixed to the second rail 322, and thereby fixing the second guide 324 to the second rail 322.

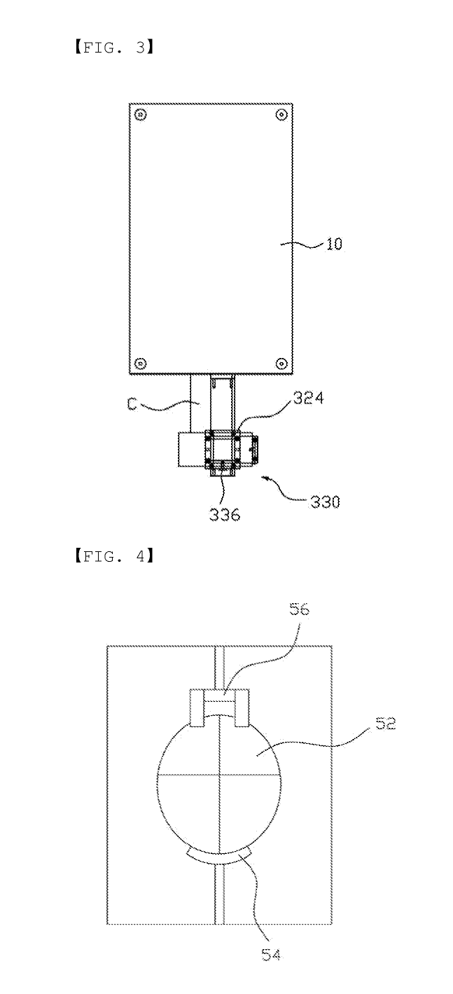

In addition, as shown in FIG. 3, the supporting portion 30 includes the third control portion 330. The third control portion 330 moves the camera C from side to side along the side surface of the casing 10.

The third control portion 330 includes a third rail 332 perpendicular to the second rail 322 at the upper surface of the second guide 324. As shown in FIG. 1 and FIG. 3, the third rail 332 is perpendicular to the second rail 322 and is positioned at the upper surface of the second guide 324. The third guide 334 that the camera C is mounted thereon moves from side to side along the third rail 332 at the side surface of the casing 10.

The third guide 334 is provided with a third set screw 336. The third set screw 336 penetrates the third guide 334 and is fixed to the third rail 332, and thereby fixing the third guide 334 to the third rail 332.

Further, the skin photographing apparatus according to the embodiment includes the cover portion 40. The cover portion 40 shields the hole 14 penetrating the side surface of the casing 10 where the supporting portion 30 is installed.

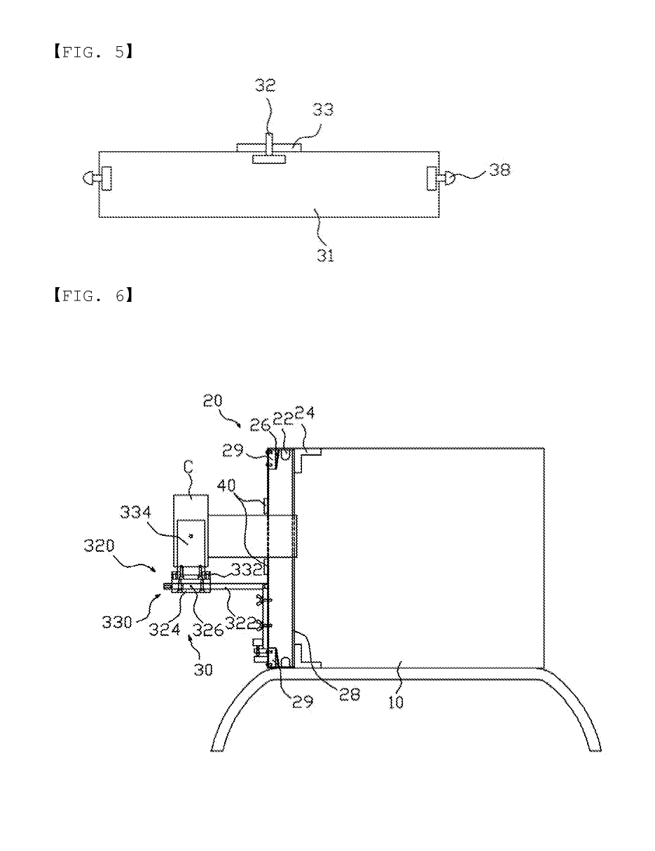

Various types or structures for shielding the hole 14 may be applied to the cover portion 40. For example, as shown in FIG. 5, the cover portion 40 is formed of an elastic material and extends from an edge of the hole 14 toward a center of the hole 14, and is an membrane or a film incised or cut toward a center. The membrane or the film may include a plurality of layers, and thereby maximizing the effect for shielding the hole 14.

The cover portion 40 may separately include a plurality of cover portions 40 of plate shapes. The plurality of cover portions 40 of the plate shapes have holes corresponding to various sizes of camera lenses, respectively. That is, each of the cover portions 40 may correspond to each of camera lenses, respectively, and thus the cover portions 40 can be replaced with each other according to the camera lens.

Also, the skin photographing apparatus according to the embodiment includes the subject-mounted portion 50. The subject-mounted portion 50 is formed at a side surface facing the side surface of the casing 10 where the supporting portion 30 is positioned. As shown in FIG. 4, the subject-mounted portion 50 includes a subject-mounted hole 52 that can be open so that a face of a person for photographing can be inserted into the casing 10, a lower supporting portion 54 positioned at a lower side of the subject-mounted hole 52, and an upper supporting portion 56 positioned at an upper side of the subject-mounted hole 52.

Hereinafter, operating procedures of the skin photographing apparatus according to the embodiment having the above structure will be described in detail.

First, a user installs a camera to the skin photographing apparatus according to the embodiment. In this instance, the camera is mounted on the third guide 334 of the third control portion 330. And then, the first guide 312 of the first control portion 310 moves along the guide hole 12 so that the lens of the camera is positioned at the hole 14.

After the lens of the camera is positioned at the hole 14, the first guide 312 is fixed to the side wall of the casing 10 by tightening the first set screw 314 of the first control portion 310.

And then, the third guide 334 of the third control portion 330 moves along the third rail 332 from side to side, and thus, the lens of the camera is positioned at the hole 14. And then, by tightening the third set screw 336, the third guide 334 is fixed. In addition, the second guide 324 of the second control portion 320 moves along the second rail 322 toward the casing 10. After the lens of the camera is inserted into the hole 14, the camera is fixed by fixing the second set screw 326.

And then, after the face of the person for photographing is mounted on the subject-mounted portion, a picture is taken by using the camera. Accordingly, an image of the skin is obtained.

Next, a skin photographing apparatus according to a second embodiment of the invention will be described with reference to the accompanying drawings.

As shown in FIG. 8, the skin photographing apparatus according to the embodiment includes a bottom surface 510, a subject-mounted portion 520, a rail portion 530, and a supporting portion 540. The bottom surface 510 is horizontally positioned. The subject-mounted portion 520 is positioned to be perpendicular to the bottom surface 510. The subject-mounted portion 520 is a portion where a face of a person for photographing is mounted. The rail portion 530 extends from the subject-mounted portion 520 to be parallel to the bottom surface 510. A camera C is mounted on an upper side of the supporting portion 540, and the supporting portion 540 moves along the rail portion 530 to get near to or grow apart from the subject-mounted portion 520.

First, the skin photographing apparatus according to the embodiment includes the bottom surface 510. Various elements or components (that constitute the skin photographing apparatus and will be described later) are positioned on or at the bottom surface 510.

The subject-mounted portion 520 is positioned at the bottom surface 510. The subject-mounted portion 520 is vertically positioned to be perpendicular to the bottom surface 510. Also, the subject-mounted portion 520 is formed so that the face of a person for photographing is mounted on the subject-mounted portion 520.

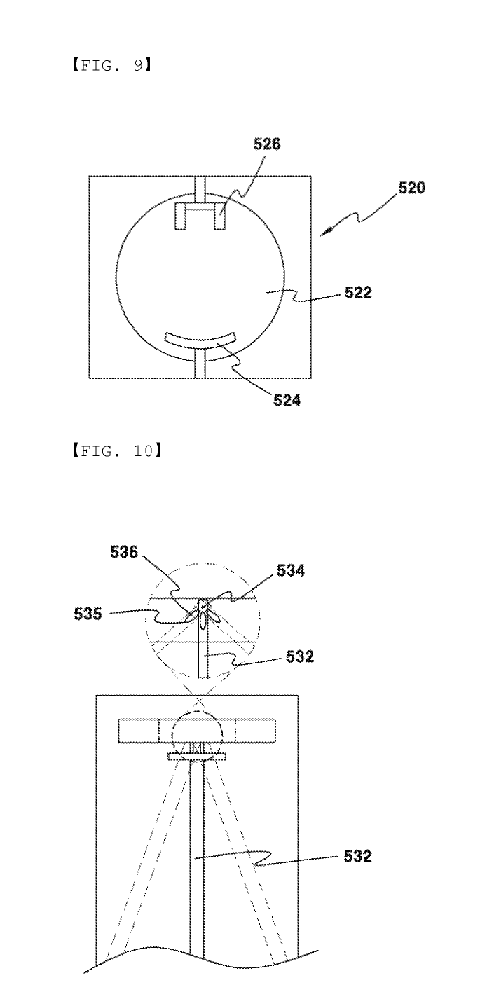

The subject-mounted portion 520 may consist of various elements to achieve the above function. For example, as shown in FIG. 9, the subject-mounted portion 520 includes a subject-mounted hole 522 that is open so that a face of a person can pass, a lower supporting portion 524 positioned at a lower side of the subject-mounted hole 52, and an upper supporting portion 526 positioned at an upper side of the subject-mounted hole 52.

Also, the skin photographing apparatus according to the embodiment includes the rail portion 530. As shown in FIG. 10, the rail portion 530 may have a bar shape that is parallel to the bottom surface 510 and extends from the subject-mounted portion 520 in one direction.

The rail portion 530 is formed so that the supporting portion 540 that will be described later moves along the rail portion 530. The rail portion 530 may includes at least one supporting-portion rail 532.

The supporting-portion rail 532 of the rail portion 530 is pivotable around the subject-mounted portion 520. The camera C mounted on the supporting-portion rail 532 is pivotable around the subject-mounted portion 520, and thus, a face of the person can be photographed at several angles (for example, a front surface and a side surface of the person can be photographed).

A structure for pivoting the supporting-portion rail 532 around the subject-mounted portion 520 includes a pivoting axis 534 and the supporting-portion rail 532, as shown in FIG. 10. The pivoting axis 534 is formed at the lower side of the subject-mounted portion 520. The supporting-portion rail 532 is pivotable around the pivoting axis 534. Protrusions 535 are radically formed around the pivoting axis at a portion where the supporting-portion rail 532 and the pivoting axis 534 are contact. Therefore, grooves 536 of the lower side of the subject-mounted portion 520 are engaged with the protrusions 535, and thus, the supporting-portion rail 532 can be fixed at the predetermined angle.

Also, the supporting portion 540 is formed at the upper side of the rail portion 530. As shown in FIG. 8, the supporting portion 540 moves along the supporting-portion rail 532 of the rail portion 530 so that the supporting portion 540 gets near to or grows apart from the subject-mounted portion 520.

The supporting-portion rail 532 of the rail portion 530 and the supporting portion 540 may include one or more of various elements to achieve the above function. For example, the supporting-portion rail 532 of the rail portion 530 and the supporting portion 540 may be an LM guide.

As shown in FIG. 8, the supporting portion 540 moves along the supporting-portion rail 532 and the camera C is mounted on and fixed to the upper side of the supporting portion 540. The supporting portion 540 moves the camera up and down, and from side to side.

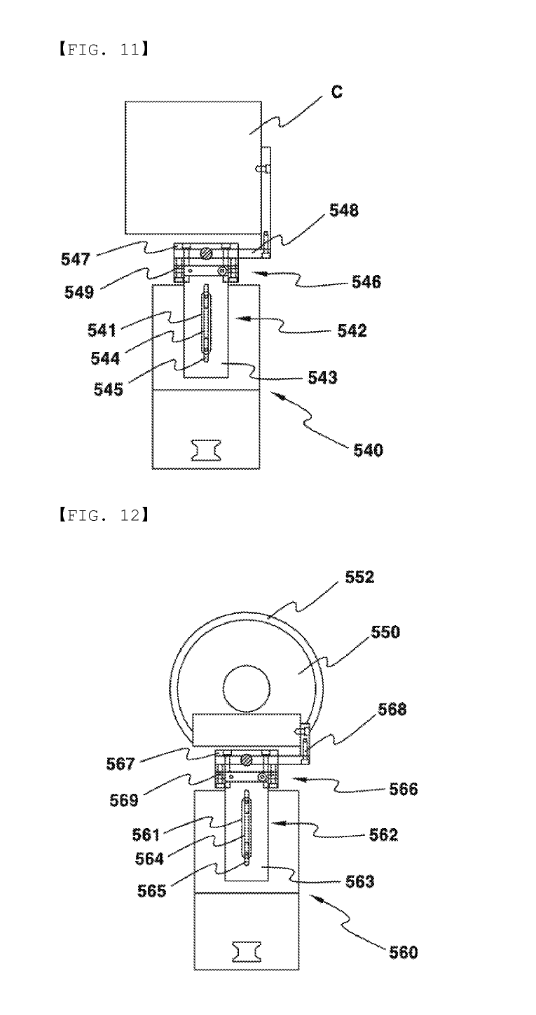

As shown in FIG. 11, the supporting portion 540 includes a first control supporting portion 542 and a second control supporting portion 546. The first control supporting portion 542 supports the lower portion of the camera C and is fixed to be movable up and down along a guide hole 541 of the supporting portion 540. The second control supporting portion 546 is fixed so that the camera C is horizontally movable.

First, as shown in FIG. 11, the supporting portion 540 includes the first control supporting portion 542. The first control supporting portion 542 includes the first guide 543. The first guide 543 is formed at the side surface of the supporting portion 540 and moves the camera C up and down. A plurality of penetrating holes 544 are formed at the first guide 543 in a longitudinal direction of the first guide 543. The penetrating holes 544 correspond to the guide hole 541 formed at a side wall of the supporting portion 540.

The penetrating hole 544 of the first guide 543 is provided with a first set screw 545. The first set screw 545 penetrates the penetrating hole 544 and is fixed to the guide hole 541, and thereby fixing the first guide 543 to the support portion 540.

Also, the supporting portion 540 includes the second control supporting portion 546. The second control supporting portion 546 moves from side to side along the side surface of the supporting portion 540.

The second control supporting portion 546 includes a control supporting-portion rail 547 formed at the upper surface of the supporting portion 540. The control supporting-portion rail 547 is perpendicular to the supporting-portion rail 532. A second guide 548 where the camera C is mounted is formed at the control supporting-portion rail 547. The second guide 548 moves the camera C to be perpendicular to the supporting-portion rail 532 along the supporting-portion rail 547.

The second guide 548 is provided with a second set screw 549. The second set screw 549 penetrates the second guide 548 and is fixed to the control supporting-portion rail 547, and thereby fixing the second guide 548 to the control supporting-portion rail 547.

In addition, the supporting portion 540 may further include a control box (not shown). The control box controls an operation of the camera C and a lighting portion 552 of a reflector 550 that will be described later.

The reflector 550 is further included at the lens of the camera C. As shown in FIG. 8, the reflector 550 extends from an edge of the lens to the subject-mounted portion 520 to have a conical shape.

A reflector-supporting portion 560 is formed at a lower side of the reflector 550. The reflector-supporting portion 560 can move along the supporting-portion rail 532 of the rail portion 530, like the supporting portion 540.

Elements same as elements of the supporting portion 540 may be included at an upper surface of the reflector-supporting portion 560 for moving the reflector 550 up and down and from side to side.

As shown in FIG. 12, the reflector-supporting portion 560 may include a third control supporting portion 562 and a fourth control supporting portion 566. The third control supporting portion 562 supports an lower side of the reflector 550 and is fixed to be movable up and down along the guide hole 561 of the reflector-supporting portion 560. The fourth control supporting portion 566 is fixed so that the reflector 550 can horizontally move from side to side.

First, as shown in FIG. 12, the reflector-supporting portion 560 includes the third control supporting portion 562. The third control supporting portion supporting portion 562 includes a third guide 563 at the side surface of the reflector-supporting portion 560. The third guide 563 moves the reflector 550 up and down. A plurality of penetrating holes 564 are formed at the third guide 563 in a longitudinal direction of the third guide 563. The penetrating holes 563 correspond to the guide hole 561 formed at a side wall of the reflector-supporting portion 560.

The penetrating hole 564 of the third guide 563 is provided with a third set screw 565. The third set screw 565 penetrates the penetrating hole 564 and is fixed to the guide hole 561, and thereby fixing the third guide 563 to the reflector-supporting portion 560.

Also, the reflector-supporting portion 560 includes the fourth control supporting portion 566. The fourth control supporting portion 566 moves the reflector 550 from side to side along one side surface of the reflector-supporting portion 560.

The fourth control supporting portion supporting portion 566 includes a guide rail 567 positioned at the upper surface of the reflector-supporting portion 560. The guide rail 567 is perpendicular to the supporting-portion rail 532. The guide rail 567 includes a fourth guide 568 that the reflector 550 is mounted thereon. The fourth guide 568 moves the reflector 550 along the guide rail 567 to be perpendicular to the supporting-portion rail 532.

The fourth guide 568 is provided with a fourth set screw 569. The fourth guide 569 penetrates the fourth guide 568 and is fixed to the guide rail 567, and thereby fixing the fourth guide 568 to the guide rail 567.

The lighting portion 552 is further formed at an edge of the reflector 550. The lighting portion 552 has a doughnut shape which front side is open, and thereby irradiating the light of the lamp of the inner light emitting diodes to the subject-mounted portion 520. A diffuser plate is formed at a side of the lighting portion 552, and thereby uniformly irradiating the light of the lighting portion 552.

Also, an illuminance sensor (not shown) is further formed at the reflector 550. By the illuminance sensor, an intensity of illumination of the light of the lighting portion 552 can be controlled.

In addition, the skin photographing apparatus according to the embodiment further includes a casing having an inner space to protect the supporting portion, the rail portion, and so on.

Hereinafter, operating procedures of the skin photographing apparatus according to the embodiment having the above structure will be described in detail.

First, a user installs a camera to the skin photographing apparatus according to the embodiment. In this instance, the camera C is mounted on the second guide 548 of the second control portion 546. And then, the first guide 543 of the first control portion 542 moves along the guide hole 541 so that the lens of the camera is positioned at a center of a face of a person to be photographed.

After the lens of the camera is positioned at its regular position, the vertical portion is adjusted or controlled. That is, the first guide 543 is fixed to the supporting portion 540 by tightening the first set screw 545 of the first control supporting portion 542.

Also, the second guide 548 of the second control supporting portion 546 moves along the control supporting-portion rail 547 from side to side, and thereby controlling a lateral position of the camera C.

By moving the reflector-supporting portion 560 along the supporting-portion rail 532, the reflector-supporting portion 560 is positioned in front of or at the lens of the camera C. And then, by controlling the positions of the third set screw 565 and the fourth set screw 569, the reflector 550 is positioned at the lens of the camera C.

And then, after the face of the person is mounted on the subject-mounted portion 520, a picture is taken by using the camera C. Accordingly, an image of the skin is obtained. In this instance, the camera C and the reflector 550 is moved along the supporting-portion rail 532 by using the supporting portions 540 and 560, respectively. Thus, the image of the skin can be obtained at a wanted distance.

Also, by pivoting the supporting-portion rail 532 around the subject-mounted portion 520, the image of the skin can be obtained at various angles.

1. A skin photographing apparatus, comprising:
a bottom surface horizontally positioned;
a subject-mounted portion vertically positioned to be perpendicular to the bottom surface, wherein a face of a person to be photographed is mounted on the subject-mounted portion; and
a supporting portion for supporting a lower side of a camera so that the camera is mounted on an upper side of the supporting portion.

2. The skin photographing apparatus according to claim 1, further comprising:
a rail portion extending from the subject-mounted portion to be parallel to the bottom surface,
wherein the camera is mounted on the upper side of the supporting portion and moves along the rail portion so that the camera gets near to or grows apart from the subject-mounted portion.

3. The skin photographing apparatus according to claim 1, wherein the rail portion is pivotable around the subject-mounted portion.

4. The skin photographing apparatus according to claim 1, further comprising:
a reflector having a conical shape,
wherein the reflector is positioned at an edge of a lens of the camera and extends toward the subject-mounted portion.

5. The skin photographing apparatus according to claim 4, further comprising:
a lighting portion positioned at an edge of the reflector.

6. The skin photographing apparatus according to claim 1, further comprising:
a casing having an inner space;
a lighting portion positioned at an edge of one side surface of the case, wherein the lighting portion for providing lighting for the camera; and
a cover portion for shielding a hole penetrating the one side surface of the casing where the supporting portion is installed,
wherein the supporting portion is formed at an outer wall of the one side surface of the casing,
wherein the supporting portion is movable up and down, from front to back, and from side to side with respect to the casing,
wherein the camera is fixed to the upper side of the supporting portion, and
the subject-mounted portion is formed at a side surface facing the one side surface of the casing where the supporting portion is positioned.

7. The skin photographing apparatus according to claim 6, wherein the lighting portion comprises:
light emitting diode portions arranged to face each other, wherein the light emitting diode portions are formed at an edge of one side wall of the casing;
a diffuser plate for partitioning a space where the light emitting diode portions are positioned and the other space in the casing; and
a fixing plate vertically protruding to an inner side at a portion where an inner wall of the casing and the diffuser plate are in contact.

8. The skin photographing apparatus according to claim 6, wherein the supporting portion comprises:
a first control portion supporting the lower side of the camera and being fixed to be movable up and down along a guide hole of the casing;
a second control portion fixed to be movable so that the camera gets near to or grows apart from the casing; and
a third control portion fixed so that the camera horizontally moves.

9. The skin photographing apparatus according to claim 6, wherein the first control portion comprises:
a first guide having a plurality of penetrating holes formed in a longitudinal direction, wherein the plurality of penetrating holes corresponding a guide hole; and
a first set screw penetrating one of the plurality of penetrating holes and being fixed to the guide hole.

10. The skin photographing apparatus according to claim 6, wherein the second control portion comprises:
a second rail fixed to be perpendicular to the first guide;
a second guide moving along the second rail; and
a second set screw installing the second guide, wherein the second set screw penetrating the second guide and being fixed to the second rail.

11. The skin photographing apparatus according to claim 6, wherein the third control portion comprises:
a third rail formed at an upper surface of the second guide and fixed to be perpendicular to the second guide;
a third guide moving along the third rail, wherein the camera is fixed at the upper side of the third guide; and
a third set screw penetrating the third guide and being fixed to the third rail.

12. The skin photographing apparatus according to claim 6, wherein the light emitting diode portion is inclined toward the diffuser plate, and an inclined angle of the light emitting diode portion is adjustable.

13. The skin photographing apparatus according to claim 6, wherein the subject-mounted portion comprises:
a subject-mounted hole being open so that a face of a person for photographing passes into the casing through the subject-mount hole;
a lower supporting portion being positioned at a lower side of the subject-mounted hole and supporting a chin of the person; and
a upper supporting portion being positioned at an upper side of the subject-mounted hole and supporting an incline of the face of the person.
